(19) United States
(12) Patent Application Publication
(10) Pub. No.: US 2008/0147487 A1
(43) Pub. Date: Jun. 19, 2008

(54) Methods and apparatus for conversational advertising

(75) Inventor: Peter Hirshberg, San Francisco, CA (US)

Correspondence Address: BEYER WEAVER LLP, P.O. BOX 70250, OAKLAND, CA, 94612-0250, US

(73) Assignee: Technorati Inc.

(21) Appl. No.: 11/973,292

(22) Filed: Oct. 5, 2007

Related U.S. Application Data
(60) Provisional application No. 60/849,960, filed on Oct. 6, 2006.

(51) Int. Cl. G06Q 30/00

(52) U.S. Cl. 705/10; 705/14

(57) ABSTRACT

Disclosed are methods and apparatus, including computer program products, implementing and using techniques for conversational advertising. Online commentary data representing comments and/or conversation is published on a data network. Relevant commentary data associated with an electronic advertisement can be identified on one or more electronic forums accessible over the data network. The identified commentary data can be filtered according to one or more parameters. The parameters can include, for example: commentary content, conversation volume, a designated timeframe, a topic, a tag, a keyword, an index, a link, a classification scheme, an authority, a relevance measure, a meme, a word, a phrase, and/or a ranking. Advertisement content, such as selected comments and/or metadata, is determined based on the commentary data. The determined advertisement content can be provided over the data network, for instance, as an RSS feed, to the electronic advertisement for incorporation into the electronic advertisement. Further commentary data on one or more electronic forums can similarly be processed to dynamically update and refine the advertisement.

### RELATED APPLICATION DATA

The present application claims priority under 35 U.S.C. § 119(e) of co-pending and commonly assigned U.S. Provisional Patent Application No. 60/849,960, titled CONVERSATIONAL ADVERTISING AND RELATED TOOLKIT, filed Oct. 6, 2006, Attorney Docket No. TECHP007P, which is hereby incorporated by reference.

### FIELD OF THE INVENTION

The present invention relates to the publishing of electronic advertisements on data networks, such as the Internet. More specifically, the present invention relates to the dynamic syndication of content in electronic advertisements based on monitored online conversations.

### BACKGROUND OF THE INVENTION

A vast array of software solutions facilitates the publishing of user-generated content on the World Wide Web (“web”) and the Internet. Some solutions are hosted. Others operate from a user's machine or server. Some are highly configurable, providing source code which the user may customize.

A “blog” (short for web log) is a website where user-generated entries are received and published, often in reverse chronological order. Many consider blogs part of a wider network of “social media,” referring to online communications platforms and practices that people use to share opinions, insights, experiences, and perspectives. Thus, the ability for users to post and read comments in an interactive format is an important part of many blogs.

Blogs often provide commentary on a particular subject such as food, politics, or local news. There may be a number of subject matter categories, with topics and sub-topics arranged on a single blog. A typical blog might include a series of postings by one or more “bloggers,” or authors of the content in the postings, relating to one or more topics.

Many blogs are primarily textual and hypertextual in content. An increasing number of blogs also combine and publish image data, video data, and audio data. A blog posting can include, for example, a link to an article relating to a current event being discussed, a link to another blog upon which the blogger is commenting or to which the blogger is responding, or a link to an authority on the subject of the posting. Blogs may also contain links outside of the regular postings which point to sites or documents in which the blogger has an interest, or to other blogs (i.e., blog roll). Blogs often include a calendar with links to an archive of historical postings on the blog. Obviously, these are merely exemplary characteristics of a blog.

Blogs are only one example of mechanisms by which content may be dynamically published in electronic networks. The point is that there is a huge amount of content being dynamically generated and published on the Web and the Internet which includes links to other content and information, and which may be thought of as ongoing “conversations.”

As has been posited on the Internet, one can think of these ongoing and interconnected conversations as markets (e.g., see The Cluetrain Manifesto). This is to be contrasted with the traditional market model which defines markets primarily with respect to transactions. Relying primarily on information relating to transactions to monitor or evaluate a market arguably misses the most relevant information relating to the market. When one begins to focus on the substance of the conversations relating to a particular market rather than mere transaction data, it becomes important to track these conversations in meaningful and timely ways.

Internet websites provide the platform for modern wide area E-commerce markets and activities, as well as the forums for conversations discussing the activities. With the proliferation of blogs, any member of the general public with a computer and Internet access can blog about a variety of markets, and likely have their postings read by users around the world. Consequently, blogs are becoming increasingly popular for users to express opinions and converse about corporations, individual business owners, politicians, other organizations, and various entities engaging in modern and traditional advertising practices.

A typical online advertising scenario involves an advertiser conducting a marketing campaign by displaying electronic advertisements on various web sites. Some advertisers and advertisements are identified with a brand, for instance, in the form of a name, phrase, or logo. The brand is often associated with some service or product provided by the advertiser. Thus, the public perception of the brand, or brand “image,” often goes hand-in-hand with the perceived quality of the advertiser's services or products.

Most advertisers are interested in learning of public reaction to their advertisements, brands, products, and services, and receiving this feedback in a timely manner. This holds true even when the advertiser believes it has no brand image concerns. Advertisers who listen to individual responses to the ads can better understand their consumers, craft and deliver more relevant and effective ads, and provide better products and services.

Public perception of a brand can be affected by a variety of factors, in addition to the quality of its services or products. Such factors include the advertiser's social and political actions, as well as its perceived responsibilities. A brand image can be tarnished in a manner undesirable to the advertiser. In such situations, the advertiser has a desire to address negative comments, attempt to steer public opinion in a more favorable direction, and to do so in a timely manner.

Often an advertiser does not learn of a brand image issue until after months of decreased sales and lost opportunities. There are significant delays associated with learning of public reaction through surveys, news reports, and other traditional methods. Also, the comments may be moot or of questionable relevance by the time they reach individuals having the power to address them. Significant delays and expenses are incurred when further investigation is needed to confirm a comment, discuss how to handle it, and finally craft and publish appropriate advertisements.

With the wide availability of blogs, computer users have the ability to immediately respond to advertisements and brands, in the form of postings and conversations on discussion forums. Unfortunately, there are no existing techniques for effectively monitoring and processing such conversations, regardless of whether the comments are positive or negative. Thus, advertisers are currently unable to identify and respond to relevant blog postings in a systematic and timely manner.

### SUMMARY OF THE INVENTION

Aspects of the present invention relate to methods and apparatus, including computer program products, implementing and using techniques for conversational advertising.

According to one aspect of the invention, a method is provided for monitoring online comments, sometimes forming parts of an online conversation, on a data network. Relevant commentary data, that is, electronically published comments and any accompanying data, associated with an electronic advertisement can be identified on one or more electronic forums accessible over the data network. The identified commentary data can also be filtered according to one or more parameters. Advertisement content, such as selected comments and/or metadata, can be determined based on the commentary data. The determined advertisement content can be provided to the electronic advertisement over the data network for incorporation into the electronic advertisement.

According to one aspect of the invention, data processing apparatus is provided for conversational advertising. The apparatus can include a conversation monitoring module coupled to monitor online comments and conversation on a data network. The monitoring module includes a search module configured to identify commentary data of interest on one or more electronic forums accessible over the data network. The monitoring module can also include a filtering module coupled to filter the identified commentary data according to one or more parameters. An advertising content determining module can be coupled to determine advertisement content based on the commentary data. A dynamic update module can be coupled to provide the determined advertisement content to the electronic advertisement over the data network.

In one implementation, the parameters can include one or more of: commentary content, conversation volume, and a designated timeframe. In one implementation, the parameters can also including one or more of: a topic, a tag, a keyword, an index, a link, a classification scheme, an authority, and a relevance measure. In one implementation, the parameters can also include one or more of: an identified and/or determined meme, word, phrase, and a ranking.

In one implementation, further commentary data on one or more of the electronic forums accessible can be identified. The identified further data can similarly be filtered according to one or more parameters, and further advertisement content can be determined based on the filtered further conversation data. The determined further advertisement content can be provided over the data network to dynamically update and refine the electronic advertisement.

In one implementation, determining the advertisement content can include: selecting a portion of the filtered commentary data, identifying and selecting metadata associated with the comments, determining metadata based on the commentary data, excluding a portion of the commentary data, retrieving the advertisement content from a storage medium, and receiving a selection of the advertisement content from a moderator associated with the electronic advertisement. The determined advertisement content can be provided, for example, as an RSS feed to the electronic advertisement.

A further understanding of the nature and advantages of the present invention may be realized by reference to the remaining portions of the specification and the drawings.

### BRIEF DESCRIPTION OF THE DRAWINGS

FIG. 1 is a simplified network block diagram of a system including apparatus implementing techniques for conversational advertising, constructed according to one embodiment of the invention.

FIG. 2 is a simplified flow diagram of a method implementing techniques for conversational advertising, performed in accordance with one embodiment of the invention.

FIG. 3 is a simplified network diagram of a system for data aggregation and search, constructed according to one embodiment of the invention.

FIG. 4 is a simplified flow diagram of a method for aggregating data in a network environment, performed in accordance with one embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention enable an advertiser to automatically detect and monitor relevant online conversations, digest published comments in near real time, and respond by dynamically changing or generating advertisement content. Ad content can be syndicated rapidly, so the advertiser can respond in near real time, often in a matter of seconds or minutes. Also, advertisers are able to embrace communities of audience members by dynamically incorporating the thoughts and comments of authors in the audience as part of the advertising scheme.

Exemplary methods and apparatus, including computer program products, are disclosed for monitoring conversations in the blogosphere, generally referring to blog postings and other user-generated comments and content electronically published on one or more network-based communications forums, such as a blog, and accessible over one or more data networks, such as the Internet. Embodiments of the invention provide techniques for identifying, searching, and filtering blog postings and other published commentary regarding a brand or topic of interest to an advertiser, and dynamically determining the content of an online advertisement responsive to the monitored conversations in near real time. For example, one or more postings can be selected, filtered, and output to a web page or electronic advertisement on the page as new content to be integrated and displayed with the advertisement. Further blog postings responding to the altered or new advertisement can be similarly identified, monitored, and processed to provide further updates to the electronic advertisement.

Exemplary methods and apparatus disclosed herein provide for electronic ads to be dynamically changed and generated using various data sources, including text data, graphical data, and audio data, according to the content and volume of conversations occurring online at a given moment or over a designated timeframe. Advertisement content extracted from conversations of interest or selected in response to the conversations is syndicated into updated versions of an electronic advertisement.

Advertisers who implement the systems, apparatus, and methods described herein are provided with tools to build and solidify relationships with their customers. With the wider usage and accessibility of online commentary, advertisers are able to identify online communities of customers, and forge relationships between its brand and those communities. Tools described herein, such as the intelligent identification and incorporation of blog postings and other online commentary as part of an ad, facilitate this objective. Using the content searching, filtering, and determining techniques described herein, advertisers are able to not only monitor blogs, but also engage and build relationships which ultimately become more meaningful and useful to both the advertiser and its customers over time.

The hardware and processing techniques described herein provide advertisers with the ability to track conversations using methods of aggregation, search, and related techniques. In addition, advertisers are provided with the capability to engage their audience in a conversation, and even influence the conversation. For example, an advertiser can publish its own comments or questions inviting audience response in advertising units published on web sites, in near real time. In addition, using techniques described herein, one or more audience members who respond to an electronic advertisement can influence and directly determine the content of the ad when displayed to other audience members, in near real time. In other words, one user can affect the state of an ad as viewed by other users, as the advertisement evolves over a campaign. The ads become participatory and interactive.

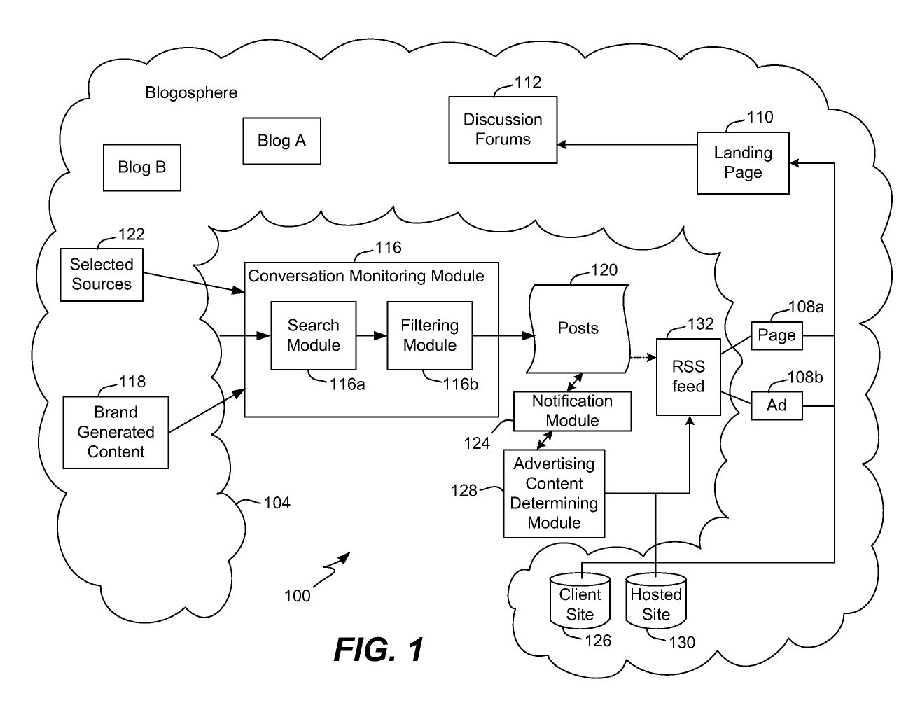

FIG. 1 shows a network diagram of a system 100 for conversational advertising, constructed according to one embodiment of the invention. The system 100 provides for the dynamic generation and/or updating of ad units 108, responsive to monitored commentary and conversations in a blogosphere 104. In one embodiment, an electronic ad unit 108 contains an electronic advertisement with data such as text, graphical (including static image and video) information, audio, and other data. The term ad unit 108, as used herein, can refer to an electronic medium such as a web page 108a, on which the advertisement data is published, or the electronic advertisement 108b itself, which may exist in published or unpublished form as data on a suitable storage medium. The graphical and textual content of the electronic advertisement, often associated with a brand or particular products or services, can be published as ad units 108 across any number of web pages. The modules and apparatus described herein are operatively coupled to output information to the ads 108. By way of example, the ad units 108 can be configured as one or more of the following, alone or in combination: feed ads, video thumbnail ads, post ads, and visualization ads. Post ads include authored content, while visualization ads have information generated based on associated metadata, for instance, illustrating popular topics, and/or changing popularity of those topics. Post and visualization ads are examples of ads often created on behalf of an advertiser.

In FIG. 1, responses to the content of the ad unit 108, and/or discussion of the brand associated with the ad, are often input by individuals on various electronic discussion forums 112 such as blogs A and B. In some implementations, an ad unit 108 links to a click-through or “landing” web page 110, which presents a fuller collection of user-generated comments and information related to the ad unit 108, and is synchronized with the ad unit 108. The ad unit 108 is often configured to provide a sampling or portion of the content on the landing page 110. For instance, readers may approve or disapprove of the ad, or have particular issues or criticisms, and express those thoughts as textual postings on the landing page 110.

In FIG. 1, in some implementations, readers may also express comments on or other blogs and suitable online forums, such as client sites 126 and hosted sites 130, accessible through the ad unit 108. A reader can access the landing page 110, or other pages on client sites 126, and hosted sites 130, by clicking on an appropriate link on the ad unit 108. The one or more blog postings on the various pages and sites 110, 126, and 130, often form conversations, as described above, which are all part of the blogosphere 104.

In FIG. 1, in one embodiment, a conversation monitoring module 116 detects an online conversation or one or more blog postings, published in the blogosphere 104 regarding an advertiser's brand, product, service, social responsibility, or other subject matter of interest to the advertiser or entity for which the advertisement 108 is being run. In one embodiment, selected sources 122 are directly coupled to conversation monitoring module 116. For instance, servers hosting online discussion forums with published comments and content known to be of particular interest to a specific subject or topic, such as parental blogs, or political blogs, can be directly coupled to conversation monitoring module 116. In this way, conversation monitoring module 116 will automatically receive these comments.

In FIG. 1, in one embodiment, the monitoring module 116 includes a search module 116a coupled to search one or more blogs in the blogosphere 104 using ecosystem techniques to identify the postings and/or conversations of interest. In one implementation, the monitoring module 116 is configured to continuously check forums in the blogosphere 104 for conversations of interest. In another implementation, monitoring module 116 is programmed to search and identify blog postings at designated update intervals. Accordingly, the content of the displayed ad unit 108 can vary at arbitrary or designated times, for instance, every 10 minutes or every hour.

In FIG. 1, in one embodiment, the conversation monitoring module 116 includes a filtering module 116b coupled to filter the results, that is, the postings identified by the search module 116a, to ascertain a set or sub-set of desired posts 120, often filtered according to one or more user-defined preferences. For example, postings can be filtered to identify conversation data that relate to topics, tags, keywords, indices, or other parameters as designated by the advertiser or other entity associated with the brand. The aggregate set of posts 120 are output from filtering module 116b. In one embodiment, a notification module 124 is coupled to notify the advertiser of the filtered posts 120, including sending a notification message of posting-related information such as content, data volume, and conversation timeframe.

Some embodiments of the present invention implement all or part of the conversation monitoring module 116, such as the search module 116a, in the form of an event and metadata based system, incorporating mechanisms by which dynamic content on the Web and the Internet is indexed, monitored, and evaluated substantially in real time. One preferred system for implementing the conversation monitoring module 116 is described in U.S. patent application Ser. No. 11/157,491, titled ECOSYSTEM METHOD OF AGGREGATION AND SEARCH AND RELATED TECHNIQUES, filed Jun. 20, 2005, (Attorney Docket No. TECHP001), which is incorporated herein by reference in its entirety for all purposes. Using techniques described therein, content can be gathered from blogs, indexed, searched, and retrieved using mechanisms and parameters such as keywords, tags, links, indexes, and classification schemes. Thus, the conversation monitoring module 116 can be implemented on one or more servers or other suitable data processing apparatus and configured to gather conversation data regarding the advertiser using such parameters. In an alternative embodiment, the search module 116a is implemented using conventional web page scrape techniques.

In one embodiment, the search module 116a of conversation monitoring module 116 is configured to search and aggregate data in the blogosphere 104 according to defined search parameters. Thus, content matching an advertiser's pre-defined criteria for conversations of interest in the blogosphere, for instance, can be retrieved. A list of favorite blogs can be monitored, and conversations having certain keywords, tags, URLs, and various content of interest can be identified.

In one embodiment, the conversation monitoring module 116 incorporates phrase analysis and meme detection services and processes, such as those described in Chim et al., U.S. patent application Ser. No. 11/466,280, titled SEMANTIC DISCOVERY ENGINE, filed Aug. 22, 2006, which is hereby incorporated by reference. For instance, implementing meme detection methods, search module 116a can be dynamically trained to identify and prioritize topics of interest to target audiences, such as topics gaining prominence among a group of bloggers concerned with a particular subject. Phrases extracted from published content and ranked, as described in U.S. patent application Ser. No. 11/466,280, can be used to automatically determine such topics. In one embodiment, search module 116a is operatively coupled to identify postings and other online commentary related to those topics of interest. The determined posts of interest are provided to automatically refine the advertisement content to respond to emerging interests of an audience, i.e., what audience members currently care about.

In an alternative embodiment, a polling process is deployed, in which an ad unit 108 queries a user as to some subject, for instance, whether they approve or disapprove, or how they rank, a brand or a topic associated with the brand. In one implementation, the conversation monitoring module 116 is coupled to directly receive user postings, for instance, inputted into text boxes of the published ad units 108, in response to the ad campaign. The ad unit 108 can also contain a prompt with a link to another website, accessible by monitoring module 116, for a reader to click through and participate. Thus, in some embodiments, postings can be directly submitted and explicitly identified as associated not only with a brand, but also with a particular marketing campaign for the brand. Brand-generated content 118, provided by or on behalf of the brand/advertiser, can also be directly provided to conversation monitoring module 116 for selection and further refinement of ad content.

In one embodiment, the filtering module 116b described above has parameters, which are controlled by an advertiser. For instance, a brand can designate certain queries and parameters as to the types of content an ad should incorporate, the timeframe for publications of content, and even individuals or groups of individuals who are considered authorities on relevant topics. In implementations incorporating meme detection techniques, such as those based on phrase selection and ranking techniques as described in U.S. patent application Ser. No. 11/466,280, filtering module 116b can be operatively coupled to extract commentary and other relevant content associated with emerging memes.

In FIG. 1, in one embodiment, an advertising content determining module 128, often operated by or on behalf of the advertiser, is coupled to select and extract content of the filtered conversation data in postings 120 for output to a web page or electronic advertisement on the page. Content can also be output to the landing page 110, one or more client sites 126, and one or more hosted sites 130, either directly from conversation monitoring module 116, or through content determining module 128, as desired for the particular implementation.

In FIG. 1, the content determining module 128 provides the advertiser with editorial control over the selection, integration, and distribution of ad content updates before being incorporated into an ad. For instance, advertisers can feature only those blog posts, which they consider appropriate. In one embodiment, the content determining module 128 is coupled to directly receive the filtered postings 120 from filtering module 116b, rather than being notified by notification module 124, as described above. In one implementation, the advertiser can act as a moderator in some capacity to through content determining module 128 to input the advertiser's own content, or select post content, relevant to goals or issues concerning the brand. In this way, the content determining module 128 provides an advertiser the capability of monitoring, participating in, and influencing a conversation of interest to the advertiser. Not only can the advertiser handle and process responses and ambient conversation happening in the blogosphere, but it can also join in the conversation in a manner that is authentic and participatory, by directly affecting the content of the ad 108.

In another embodiment, advertising content determining module 128 is automated and configured to select advertisement content based on the selected postings 120 or other conversation data according to some criteria specified by or on behalf of the advertiser. In another embodiment, the content determining module 128 provides an ad customization process capable of crafting an ad for an individual user, that is, audience member, based on a user profile.

Certain content of the filtered posts 120 can automatically be selected for syndication to the ad units 108 according to some criteria. In another example, when certain keywords or topics are identified as associated with the postings 120, graphical backgrounds can be selected from a bin based on the identified topics, and fed to the ad unit in near real time for updating. Other various content, including text, image, video, and audio data, can be programmed to be selected responsive to the identification of content or parameters associated with the postings 120.

In an alternative embodiment, the advertising content determining module 128 is bypassed or omitted from system 100, so that post content 120 output from filtering module 116b is automatically fed to the ad units 108, and to one or more client sites 126 and hosted sites 130.

In FIG. 1, a dynamic update module 132 is coupled to output the data selected by content determining module 128 as advertisement content data. For instance, when the moderator's own content is provided in response to the filtered posts 120, the moderator's content is provided to dynamic update module 132 to be fed to the ad unit 108. The update module 132 generally receives data from the content determining module 128 but, in some implementations, can also be coupled to receive filtered postings 120 directly from filtering module 116b.

In one embodiment, the dynamic update module 132 is configured to provide postings content as well as associated metadata, for example, in the form of an RSS feed, to online ad units 108 published on various web pages. In one embodiment, metadata such as popular words, tags, and/or a ranked list of words and names of products derived from online comments and conversation, can be provided to the ads 108 separate and apart from any content. In some implementations, the ad units 108 are configured to generate visual representations of the metadata, such as animated graphics illustrating size and associated magnitude of the conversations. For example, in one visualization ad, an animated bubble has a size which fluctuates relative to other animated bubbles, indicating the magnitude of online comments discussing the particular name and/or model of an automobile or other item of interest.

In this way, dynamic content updates can be repeatedly syndicated, and the ad units can be updated to integrate and display the received content in near real time to reflect or respond to online commentary published in blogosphere 104.

As mentioned above, the ad unit 108 itself can be used to instigate and provide a platform for a near real time conversation. For instance, an ad unit 108 can be published that poses a question, and includes a text box configured to receive audience commentary and provide the comments to a central data storage location coupled to the conversation monitoring module 116. In one implementation, submitted comments are indexed and extracted using the data aggregation and search system described above, filtered, and syndicated back to the ad unit 108 to dynamically update the content of the unit 108.

In a further embodiment of the present invention, the conversation monitoring module 116 can be programmed to identify online conversations regarding current events, such as social and political events happening in the world. For instance, the conversation monitoring module 116 can be configured to identify volumes of conversation data, posted on certain web sites or in other defined online spaces, and associated with designated tags or events of interest. In this implementation, the advertising content determining module 128 can be programmed to select advertisement content according to the identified postings or conversations.

In another embodiment of the present invention, ads posted on a blog or other suitable web publication are intended to provide dynamically changing and customized content for a user according to posts of information from authorities or selected individuals or groups associated with the user. For instance, the filtering module 116b can be configured to identify or define a social network of the user, and conversation data can be selected from that blog as having more relevance to the user. In another embodiment, a “favorite persons” list is maintained, in which content posted from authors on the list is identified and treated as having more relevance to the dynamic content to be displayed in an ad unit for the user. For instance, the favorite persons list could identify celebrities on a celebrity gossip blog.

In some embodiments of the present invention, one or more of the various modules described above, including the advertising content determining module 128 and/or the filtering module 116b, are implemented using a toolkit of processes and interfaces, constructed in accordance with embodiments of the present invention. For instance, the toolkit can provide user interfaces to perform editorializing on search results delivered by the search module 116a. The toolkit can include a number of APIs, also referred to herein as products, to provide the desired processes and interfaces. Using such APIs, the filtering module 116b and/or advertising content determining module 128 can be provided with mechanisms to filter the search results according to parameters such as URLs, keywords, designated tags, user profiles, user preferences, blog metadata, “top 10” or “top X” tags by popularity, related tags, blogs by tags, link, link count, keyword search matches, and other preferences.

Exemplary tools of the toolkit provide interfaces, products, and processes, to the advertiser or its agent, with the capability of collecting posts from search queries defined by the advertiser, compiling results into customized feeds to publish, change, add, and create new feeds, and outputting advertisement data in desired formats, such as RSS.

One toolkit product, described herein as “Create Feeds,” allows an advertiser to define any number of “buckets” into which selected posts can be placed. This permits the advertiser to syndicate select posts on separate topics or from a separate set of blogs to one or more ad units 108. Using this tool, the advertiser remains in control of the contents of each feed. In one implementation, each feed is designated a URL at creation allowing the advertiser to retain the ability to change the content of the feed.

Also, the toolkit can be structured to contain an “Add Posts to Feeds” product, which allows the advertiser to add a post from keyword or tag search results to any feed it has created. This tool affords the advertiser flexibility in how it finds the posts it wishes to include, such as refining/changing the search criteria, and lets the advertiser select the feeds in which to include designated posts without having to leave the search results and re-run the query.

An exemplary toolkit of the present invention can also include a “Display Feed Details” product, which allows the advertiser to view the current contents of any feed and to manage the contents of that feed, for instance, to delete or reposition posts. The advertiser is thus able to see a preview of its feed prior to publishing the feed live to the ad unit 108, reducing the risk of any unpleasant surprises, making the feed more editorially interesting, and enabling last minute editing.

Additional tools include “Set Up/Receive Keyword” and “Tag Search Results.” These tools allow advertisers to choose to syndicate a stream of posts resulting from any keyword or tag search. Advertisers can establish one-time or saved searches and syndicate the results from those searches to the ad units 108.

Additional tools can include “Delete Posts from Feed,” and “Position/Order Posts in Feed.” The “Delete Posts from Feed” tool enables the advertiser to remove a post from any of its feeds, for instance, that the advertiser deems inappropriate for its advertisement or website. The “Position/Order Posts in Feed” tool allows an advertiser to determine in what order the posts will appear within its feeds, for simplicity in parsing and displaying the data in the desired order on the advertiser's site.

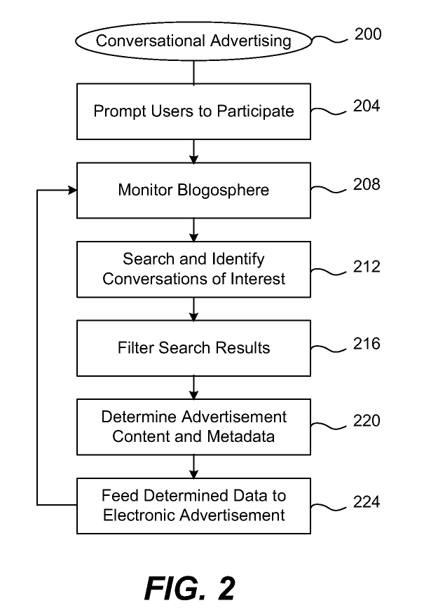

FIG. 2 shows a flow diagram of a method 200 for conversational advertising, performed in accordance with one embodiment of the present invention. The flow diagram of FIG. 2 is described with reference to the system 100 of FIG. 1. The method 200 has a feedback loop, described below, enabling the method to essentially begin at any of the various steps 204-224 described below. Thus, the diagram of FIG. 2 represents one possible illustration of the method 200, with the flow beginning at step 204, in which audience members, or users, are prompted to participate in an online advertising campaign.

In FIG. 2, in step 204, often the prompting is the publication of an electronic advertisement or ad unit 108, as explained above with reference to FIG. 1. A computer user sees the ad, reacts to it, and publishes thoughts, issues, or criticisms in one or more discussion forums 112. Concurrently, or in response to user postings, relevant content 118 can be generated by the brand. The published comments, for instance, on a blog site, often evolve into conversations in the blogosphere 104. Thus, the electronic advertisement itself can form part of a real-time conversation in the blogosphere 104. In one implementation, the ad unit 108 is interactive and explicitly requests or invites commentary from bloggers regarding the advertisement, as explained above.

In FIG. 2, in step 208, the conversation monitoring module 116 is configured to monitor postings in the blogosphere 104. For instance, as explained above, an ecosystem can be used to aggregate and index postings according to defined search techniques, such as tags, links, link-threading, subjects, keywords, and topics. In addition, techniques described herein for determining relevance and authority associated with the blog postings are used to further index and categorize blog postings monitored in the blogosphere 104. In one embodiment, the various techniques are applied by search module 116a, in step 212, to search and identify conversations of interest.

In FIG. 2, in step 216, the filtering module 116b filters the search results provided by search module 116a. The filtering module 116b serves as a post “distiller,” in that the filtering module further refines the set of postings desired to be returned to the advertiser. In one embodiment, the filtering module 116b is programmed with editorial mechanisms, such as metadata-based filtering techniques, to identify the most desired results returned by search module 116a. Thus, to this end, the “posts” 120 can also include associated metadata. In step 216, in addition to focusing on certain parameters used by search module 116a, as described above, the filtering module 116b can apply metrics such as term frequency and term density, as well as authority-based metrics such as identifying authors who publish with designated frequency, and/or are viewed as having authority on certain topics. One or more of the various editorial processes are applied to the search results to output a subset of postings, which are presumably of more interest to the advertiser.

In FIG. 2, in step 216, the filtering module 116b can also be programmed with topic-based metrics for filtering the search results. For instance, in one implementation, an initial screening performed by filtering module 116b identifies only postings associated with a designated authority. Then, those postings are examined for a topic mentioned in or referenced by the postings. The topic can be a subject directly related to concerns of the advertiser, or some indirectly related subject.

In FIG. 2, the method 200 proceeds to from step 216 to step 220, in which the filtered postings 120 are used to determine advertisement content and/or metadata for syndication to the ads 108. As explained above, the text of one or more posts 120 and/or associated metadata can be directly output to the ads as RSS feeds, or pass through advertising content determining module 128 where further selection and editing is performed. In step 220, the advertiser can also input its own advertisement content, responsive to the statements in the filtered postings 120, or the posting content itself or some other content can automatically be selected and output to the ads 108 by determining module 128. In another example, the content determining module 128 automatically excludes one or more of the filtered postings 120 based on some criteria.

The filtering of postings in step 216, and determining of advertisement content and metadata in step 220, described above, provide for two distinct mechanisms for filtering and editing of data to ascertain what content to output to the ad units 108. Depending on the desired implementation, the filtering and determining steps can include automated processes, manual intervention, and combinations of both. Thus, for example, when an ad unit instructs the audience to tag responsive blog postings in a certain manner to designate syndication back to the ad unit 108, the advertiser is not obligated to automatically syndicate blog postings having the indicated tag. Editorial control can be preserved for the advertiser at content determining module 128.

In FIG. 2, in step 224, the determined advertisement content and/or metadata is syndicated to one or more ad units 108, for instance, as an RSS feed. The provided advertisement content can then be integrated and displayed as part of the electronic advertisement data in the ad unit 108. As audience members see updates and/or new content in the ad unit 108, they will often generate new and further comments regarding the advertisement as postings on various blogs or other forums 112. These postings and conversations then become part of the blogosphere 104, or some other content storage platform, accessible by conversation monitoring module 116. Thus, the method 200 proceeds from step 224 back to step 208, to monitor the blogosphere and perform the same or similar sequence of operations as described with respect to steps 208-224, for further blog postings.

Implementations of the methods and apparatus described above provide for advertisement content to be syndicated in response to blog postings associated with the electronic advertisement or campaign at issue. In addition, advertisement content can be determined according to the advertiser's criteria for responding to conversations taking place in the blogosphere. Thus, various parameters and factors can be defined to influence the selection and syndication of advertisement content, as desired by the advertiser. Some advertisers may wish to exercise editorial control, as provided by the mechanisms described above. In other implementations, advertisers are comfortable with removing themselves from the loop, and allowing the marketplace of ideas to define the content of an advertisement.

According to various embodiments of the invention, the present invention allows dynamic information to be tracked, indexed, and searched in a timely manner, i.e., in near real time. According to some embodiments, such techniques take advantage of the semi-structured nature of content published on the Web to track relevant information about the content within seconds or minutes, rather than weeks.

Specific implementations of the present invention employ a “service-oriented architecture” (SOA) in which the functional blocks referred to are assumed to be different types of services (i.e., software objects with well defined interfaces) interacting with other services in the ecosystem. A service-oriented architecture (SOA) is an application architecture in which all functions, or services, are defined using a description language and have invokable interfaces that are called to perform processes. Each interaction is independent of every other interaction and the interconnect protocols of the communicating devices (i.e., the infrastructure components that determine the communication system) are independent of the interfaces. Because interfaces are platform-independent, a client from any device using any operating system in any language can use the service.

It will be understood, however, that the functions and processes described herein may be implemented in a variety of other ways. It will also be understood that each of the various functional blocks described may correspond to one or more computing platforms in a network. That is, the services and processes described herein may reside on individual machines or be distributed across or among multiple machines in a network or even across networks. It should therefore be understood that the present invention may be implemented using any of a wide variety of hardware, network configurations, operating systems, computing platforms, programming languages, service oriented architectures (SOAs), communication protocols, etc., without departing from the scope of the invention.

In some of the examples below, the content publishing and management tools discussed are often referred to as tools for the creation and management of blogs. Therefore, specific embodiments of the invention are described for tracking blogs and other electronically available sources publishing RSS feeds. However, it should be understood that the techniques of the present invention may relate to any tools by which content may be generated and published in electronic networks, and should therefore not be limited by references to blogs. Examples of other such tools include, but are not limited to, wiki web page editing tools, social network profile editing tools, or any other general purpose or specialized content management system (CMS) or personal publishing tools. More generally, any state change in information on a network which can be characterized and flagged as an event as described herein may trigger the data aggregation and indexing techniques of the present invention.

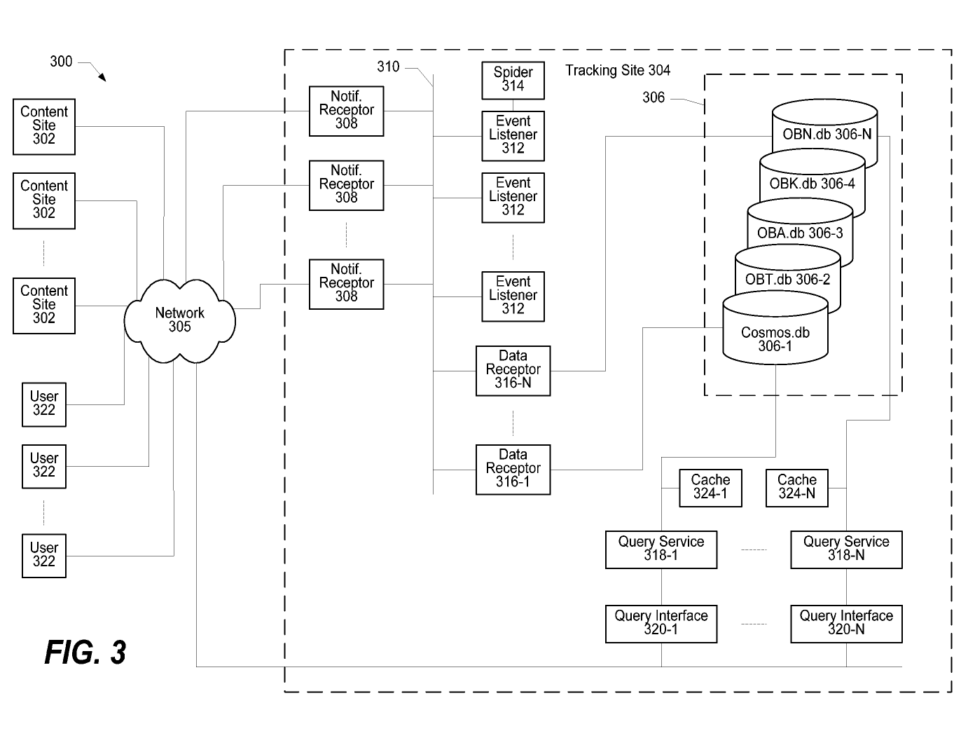

Referring now to FIG. 3, an ecosystem 300 designed according to the invention will be described. A variety of content sites 302 exist on the Web on which content is generated and published using a variety of content publishing tools and mechanisms, e.g., the blogging tools discussed above. Such publishing mechanisms may reside on the same servers or platforms on which the content resides or may be hosted services.

A tracking site 304 is provided which receives events notifications, e.g., pings, via a wide area network 305, e.g., the Internet, each time content is posted or modified at any of sites 302. So, for example, if the content is a blog which is modified using Type Pad, when the content creator publishes the changes, code associated with the publishing tool makes a connection with tracking site 304 and sends, for example, an XML remote procedure call (XML-RPC) which identifies the name and URL of the blog. Similarly, if a news site post a new article, an event notification (e.g., an XML-RPC) would be generated. Tracking site 304 then sends a “crawler” to that URL to parse the information found there for the purpose of indexing the information and/or updating information relating to the blog in database(s) 306. According to embodiments relating specifically to blogs, the parsing of the information in a blog is facilitated by the fact that most blogs are similarly configured or have a semi-structured format which either follows a general archetype or a template provided by the well known blogging tools. According to some embodiments, the spidering and parsing of a blog may also be facilitated by the use of, among other things, explicit and implicit alternate representations of the blog (e.g., feeds), external metadata (e.g., robots, sitemaps, and contact information files), and blog archives.

According to some implementations, tracking site 304 may periodically receive aggregated change information. For example, tracking site 304 may acquire change information from other “ping” services. That is, other services, e.g., Blogger, exist which accumulate information regarding the changes on sites which ping them directly. These changes are aggregated and made available on the site, e.g., as a changes.xml file. Such a file will typically have similar information as the pings described above, but may also include the time at which the identified content was modified, how often the content is updated, its URLs, and similar metadata. Tracking site 304 retrieves this information periodically, e.g., every 5 or 10 minutes, and, if it hasn't previously retrieved the file, sends a crawler to the indicated site, and indexes and scores the relevant information found there as described herein.

In addition, tracking site 304 (or closely associated devices or services) may itself accumulate similar change files for periodic incorporation into the database rather than each time a ping is received. In any case, it should be understood that embodiments of the invention are contemplated in which change information is acquired using any combination of a variety of techniques.

As will be understood, event notification mechanisms, e.g., pings, may be implemented in a wide variety of ways and may be generally characterized as mechanisms for notifying the system of state changes in dynamic content. Such mechanisms might correspond to code integrated or associated with a publishing tool (e.g., blog tool), a background application on PC or web server, etc.

According to various specific embodiments, the mechanisms which generate the pings to tracking site 304 are integrated in some way with the publishing tool(s) being used by the authors of the content being published. When an author elects to publish or post content (e.g., by selecting a “Post and Publish” object on his screen), code associated with the publishing tool establishes an HTTP connection with site 304 at a specific URL, and an HTTP “get” or “post” is transmitted in the form of an XML remote procedure call (RPC). This code may be provided by tracking site 304, and may simply be associated with or comprise an integral part of the publishing tool.

According to a specific embodiment of the invention, three different ping types are employed, referred to herein as a standard blog ping, an extended blog ping, and a non-blog ping. A standard ping has two arguments, the name of the post site or Web log and the URL. An extended ping also identifies any associated RSS feed. Standard pings are generally sufficient for most blog sites given relative uniformity and semi-structured nature of the information on blog sites. The non-blog ping is intended for more traditional publishers and includes the main site URL as well as the new URL of the recently published document. This ping may identify any number of categories as self-selected by the publisher, as well as arbitrary metadata such as, for example, the author. This information is useful in that the crawler that is sent to such a site will be crawling an arbitrary HTML document as opposed to the semi-structured information in a blog. Obviously, other types of pings and event notification mechanisms may be employed without departing from the scope of the invention.

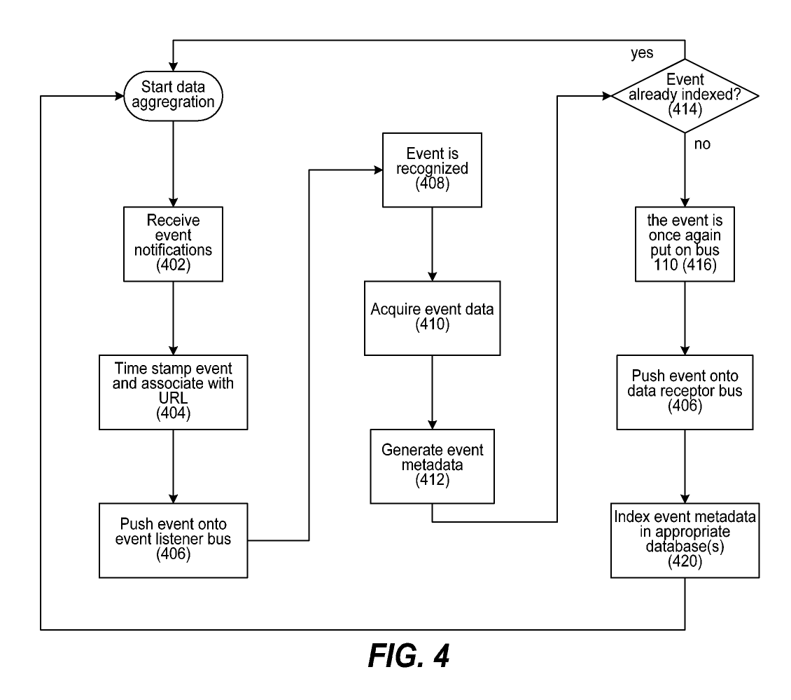

Referring now also to the flowchart of FIG. 4, one or more notification receptors 308, e.g., ping servers, act as event multiplexers taking all of the event notifications (402) coming in from a variety of different places and relating to a variety of different types of content and state changes. Each notification receptor 308 understands two very important things about these events, i.e., the time and origin. That is, notification receptor 308 time stamps every single event when it comes in and associates the time stamp with the URL from which the event originated (404). Notification receptor 308 then pushes the event onto a bus 310 on which there are a number of event listeners 312 (406).

Event listeners 312 look for different types of events, e.g., press releases, blog postings, job listings, arbitrary webpage updates, reviews, calendars, relationships, location information, etc. Some event listeners may include or be associated with spiders 314 which, in response to recognizing a particular type of event will crawl the associated URL to identify the state change which precipitated the notification. Another type of event listener might be a simple counter which counts the number of events received of all or particular types.

An event listener might include or be associated with a re-broadcast functionality which re-broadcasts each of the events it is designed to recognize to some number of peers, each of which may be designed to do the same. This, in effect, creates a federation of event listeners which may effect, for example, a load balancing scheme for a particular type of event.

Another type of event listener referred to herein as a “buzz” listener may be configured to listen for and track currently popular keywords (e.g., as determined from the content of blog postings) as an indication of topics about which people are currently talking. Yet another type of event listener looks at any text associated with an event and, using metrics like character type and frequency, identifies the language. With reference to the foregoing, it should be understood that event listeners may be configured to look for and track virtually any metric of interest.

Once an event is recognized (408) and the event data have been acquired (410) through some mechanism, e.g., a spider, the output of the event listeners is a set of metadata for each event (412) including, but not limited to, the URL (i.e., the permalink), the time stamp, the type of event, an event ID, content (where appropriate), and any other structured data or metadata associated with the event, e.g., tags, geographical information, people, events, etc. For example, the URL might indicate that the event occurred at the New York Times web site, the time stamp the time of the event, the type of event might indicate a blog post, the event ID a post ID, and the content would include the content of the blog post including any links. These metadata may be derived from the information available from the URL itself, or may be generated using some form of artificial intelligence such as, for example, the language determination algorithm mentioned above. In addition to spidering, event metadata may be generated by a variety of means including, for example, inferring known metadata locations, e.g., for feeds or profile pages.

The “crawlers” employed by specific embodiments of the present invention may not necessarily be crawlers in the conventional sense in that traditional crawlers are relatively autonomous and are not typically directed to a specific URL. By contrast, the crawlers employed by the present invention are directed to specific URLs or sets of URLs as listed, for example, in the sitemap or changes.xml file(s). These crawlers may employ parsers which are operable to break down the information being crawled and put the relevant portions, e.g., the posts, into the data model employed by the ecosystem database(s) (e.g., database(s) 306).

According to some embodiments, site 304 maintains information, e.g., hashes of previous posts, to ensure that only new information is indexed and scored. This, in turn, enables a very large version control system in which different parts of an HTML document can be “aged” differently. That is, the creation date of every separable part of an HTML document, including every link, can be tracked.

According to a specific embodiment, content may be classified based on links to an established topic directory or ontology, e.g., by looking at each piece of content and identifying outbound links and unusual phrases. An outbound link is then checked against an ontology (e.g., DMOZ (see http://dmoz.org/) or any other suitable ontology) and based on the link pattern, the content is automatically tagged as inside of that particular category. Then, a relevance weight may be assigned to the document with reference to the author's relative authority inside of that category (see below) as well as inbound links to that document inside of that category. This weight may further incorporate self-categorization, (e.g. “tags”) of blogs and posts.

A number of databases 306 are maintained in which the event metadata are stored. According to a specific implementation, each event listener and/or associated spider is operable to check the metadata for an event against the database to determine whether the event metadata have already been stored. This avoids duplicate storage of events for which multiple notifications have been generated. A variety of heuristics may be employed to determine whether a new event has already been received and stored in the database. For example, as mentioned above, a hash of the metadata may be quickly compared to hashes of metadata for other events received for a particular URL. However, this may not be sufficient in that it may not be desirable to store all content changes.

An example of a blog post may be instructive. If the intent is to store only events corresponding to new posts in a blog, it is important to be able to determine whether a received event corresponds to a new post or to some extraneous information embedded in a web page, e.g., recent sporting event scores. Blog publishing tools commonly create a metadata feed (e.g., an RSS feed or Atom feed) alongside new html. A heuristic can refer to these feeds (e.g., using link tag alternates as a sitemap) to determine whether an event corresponds to a new post. This may be done, for example, with reference to the permalink(s) identified in this feed. Permalinks are the permanent links associated with content where that content may be found despite no longer being included at a particular URL, e.g., a new site's home page.

Once event metadata have been generated/retrieved (412) and it has been determined that the event has not already been stored in the database (414), the event is once again put on bus 310 (416). A variety of data receptors 316 (1-N) are deployed on the bus which are configured to filter and detect particular types of events (418), e.g., blog posts, and to facilitate storage of the metadata for each recognized event in one or more of the databases (420).

According to a specific implementation, each data receptor is configured to facilitate storage of events into a particular database. A first set of receptors 316-1 are configured to facilitate storage of events in what will be referred to herein as the Cosmos database (cosmos.db) 306-1 which includes metadata for all events recorded by the system “since the beginning of time.” That is, cosmos.db is the system's data warehouse which represents the “truth” of the data universe associated with ecosystem 300. All other database in the ecosystem may be derived or repopulated from this data warehouse.

Another set of receptors 316-2 facilitates storage of events in a database which is ordered by time, i.e., the OBT.db 306-2. According to a specific embodiment, the information in this database is sequentially stored in fixed amounts on individual machines. That is, once the fixed amount (which roughly corresponds to a period of time, e.g., a day, or a fixed amount of storage, e.g., 4 GB RAM-based index) is stored in one machine, the data receptor(s) feeding OBT.db move on to the next machine. This allows efficient retrieval of information by date and time. For example, a user might want to know what people (or a particular person) were talking about on a particular date, or what the big events in the world were for a given time period.

Another set of data receptors 316-3 facilitates storage of event data in a database which is ordered by authority, i.e., the OBA.db 306-3. According to a specific embodiment, the information in this database is indexed by individuals and is ordered according to the authority or influence of each which may be determine, for example, by the number of people linking to each individual, e.g., linking to the individual's blog. As the number of links to individuals' changes, the ordering within the OBA.db shifts accordingly. Such an approach allows OBA.db to be segmented across machines and database segments to effect the most efficient retrieval of the information. For example, the information corresponding to authoritative individuals may be stored in a small database segment with high speed access while the information for individuals to whom very few others link may be stored in a larger, much slower segment.

Authority may also be determined and indexed with respect to a particular category or subject about which an individual writes. For example, if an individual is identified as writing primarily about the U.S. electoral system, his authority can be determined not only with respect to how many others link to him, but by how many others identifying themselves as political commentators link to him. The authority levels of the linking individuals may also be used to refine the authority determination. According to some embodiments, the category or subject to which a particular individual's authority level relates is not necessarily limited to or determined by the category or subject explicitly identified by the individual. That is, for example, if someone identifies himself as a political blogger, but writes mainly about sports, he will be likely classified in sports. This may be determined with reference to the content of his posts, e.g., keywords and/or links (e.g., a link to ESPN.com).

Yet another set of data receptors 316-4 facilitate storage of event data in a database which is ordered by keyword, i.e., the OBK.db 306-4. These data receptors take the keywords in the event metadata for an incremental keyword index which is periodically (e.g., once a minute) constructed. According to a specific embodiment, these data receptors are based on Lucene (an open source Java tool kit for text indexing and searching) and have been tuned to enable high speed, near real-time indexing of the keywords. Most conventional keyword indexers can take days or weeks to create an index. That is, conventional keyword indexers create a data set, index the entire data set, and score the entire data set. By contrast, the keyword indexers employed by the present invention build the keyword index incrementally.

According to a specific embodiment, advantage is taken of the fact that keyword search may be made highly parallel. Very thin “slices” of new index information are “layered” on top of the existing index and incorporated into the main index over time. So, for example, every minute, the keyword data receptors add the information indexed in the preceding minute on top of the existing index. When some number of these one minute slices are accumulated, e.g., five, those slices are consolidated into a single five minute slice. This repeats until some number (e.g., four) of five minute slices are accumulated which are then consolidated into a single twenty minute slice. This consolidation into thicker and thicker slices continues until a slice is consolidated which is the size of the original underlying index, at which point, consolidation with the underlying index is effected. This approach allows structured queries for information literally within minutes or even seconds of the information being posted on the Web or Internet. It should be noted that the reference to keyword indexing in this paragraph is intended to be for exemplary purposes only and should not be construed as limiting the incremental indexing technique described. To the contrary, it should be understood that this technique may be used to incorporate new index information into any type of index.

Each of the main ecosystem databases (i.e., cosmos.db, OBT.db, OBA.db, and OBK.db) includes substantially overlapping sets of information. However, each differs from the others by how the information is indexed for response time.

When a new database is created which is to be ordered by some arbitrary index, e.g., mp3 title, new data receptors are configured to facilitate indexing of events in the new database which, as mentioned above may initially be constructed from the information in cosmos.db, i.e., information about mp3s going back “to the beginning of time.” As will be understood, depending upon what is being indexed some databases will not include the entire universe of information represented in cosmos.db.

As database receptors generate new slices for particular databases, these slices are copied to a master database for each database (e.g., OBT.db, OBA.db, etc.) in the ecosystem. As will be discussed in greater detail below, there are also a number of slave database copies associated with each master database which are similarly updated and from which responses to search queries are serviced. That is, one or more query services 318 access the slaves for each database and have associated query interfaces 320 which look for and present queries appropriate to the particular database. According to specific embodiments, each slave maintains its entire copy of the database in system RAM so that the database in long term memory is, at least during run time, write only. This allows queries to be serviced much more quickly than if database reads had to access long term memory. Of course, it will be understood that this optimization is not necessary to implement the invention. For example, according to other embodiments, different segments of the master database may reside in different slaves. In one example, each slave in a cluster might store one week's worth of postings and articles from blogs and news sites. It will be understood that the manner in which data are stored or segmented across the slaves of a cluster may vary without departing from the invention.

Once the event metadata are indexed in the database, they are accessible to query services 318 which service queries by users 322. In contrast with the approach taken by the typical search engine, this process typically takes less than a minute. That is, within a minute of changes being posted on the Web, the changes are available via query services 318. Thus, embodiments of the present invention make it possible to track conversations on any subject substantially in real time.

According to some embodiments, caching subsystems 324 (which may be part of or associated with the query services) are provided between the query services and the database(s). The caching subsystems are stored in smaller, faster memory than the databases and allow the system to handle spikes in requests for particular information. Information may be stored in the caching subsystems according to any of a variety of well known techniques, but due to the real-time nature of the ecosystem, it is desirable to limit the time that any information is allowed to reside in the cache to a relatively short period of time, e.g., on the order of minutes. According to a specific implementation, the caching subsystem is based on the well known open source software Memcached. Information is inserted into the cache with an expiration time at which time, the information is deleted or marked as “dirty.” If the cache fills up, it operates according to any of a variety of well known techniques, e.g., a “least recently used” (LRU) algorithm, to determine which information is to be deleted.

The ecosystem of the present invention represents a fundamental paradigm shift in the way in which data are aggregated and made searchable. Instead of the conventional paradigm of simply inserting data in one side of a database and then pulling it from the other, the universe of data on the Internet and the Web may be conceptualized and monitored as “streams” of information. Very simple, very fast applications (e.g., event listeners and data receptors) are constructed which do nothing but look for and capture specific streams of information which are then indexed, stored, and made searchable in near real time. And because these applications are all operating in parallel, the information for any given “stream” does not need to be first pulled out of some large data warehouse before it can be made available.

According to various embodiments, the event listeners and data receptors described above may be constructed from a variety of open source and proprietary software including, for example, Linux, Apache, MySQL, Python, Perl, PHP, Java, Lucene. According to a specific embodiment, the message bus is based on open source software known as Spread. Spread is a toolkit that provides a high performance messaging service that is resilient to faults across external or internal networks. Spread functions as a unified message bus for distributed applications, and provides highly tuned application-level multicast and group communication support.

According to various specific embodiments, access to the information accumulated by tracking site 304 may be provided in a variety of ways. A wide variety of mechanisms may be employed to enable users to get at information of interest indexed in the ecosystem. For example, conventional looking search interfaces may be employed which include text boxes in which users may enter keywords, phrases, URLs, etc. More advanced search tools may also be provided which, for example, enable the construction of Boolean expressions.

Regardless of the search interface employed, query services 318 corresponding to each of the databases in the ecosystem (e.g., cosmos.db, OBT.db, OBA.db, OBK.db, etc.) look at incoming search queries (via query interfaces 320) to determine type, e.g., a keyword vs. URL search, with reference to the syntax or semantics of the query, e.g., does the query text include spaces, dots (e.g., “dot” com), etc. According to embodiments employing a service oriented architecture (SOA), these query services are deployed in the architecture to statelessly handle queries substantially in real time.

When a query service recognizes a search query which corresponds to its database, it presents the query to one or more of the slaves for that database according to any suitable load balancing scheme and/or according to how the data are organized across the slaves. For example, using the example mentioned above in which each slave stores a particular week's worth of postings or articles, a query for the 20 most recent postings on a particular subject might result in a query service associated with OBT.db connecting with some number slaves associated with that database and corresponding to the most recent weeks. Similarly, a query for the 20 most authoritative blog posts referring to a particular New York Times article would result in a query service associated with OBA.db connecting with some number of slaves associated with that database. If the first slaves to which the query service connects can fully satisfy the query, no further slaves need to be consulted. On the other hand, the query service might need to connect with additional slaves if the requested number of results are not returned from the first set of slaves.

Keyword searching may be used to identify conversations relating to specific subjects or issues. “Cosmos” searching may enable identification of linking relationships. Using this capability, for example, a blogger could find out who is linking to his blog. This capability can be particularly powerful when one considers the aggregate nature of blogs.

That is, the collective community of bloggers is acting, essentially, as a very large collaborative filter on the world of information on the Web. The links they create are their votes on the relevance and/or importance of particular information. And the semi-structured nature of blogs enables a systematic approach to capturing and indexing relevant information. Providing systematic and timely access to relevant portions of the information which results from this collaborative process allows specific users to identify existing economies relating to the things in which they have an interest.

By being able to track links to particular content, embodiments of the invention enable access to two important kinds of statistical information. First, it is possible to identify the subjects about which a large number of people are having conversations. And the timeliness with which this information is acquired and indexed ensures that these conversations are reflective of the current state of the “market” or “economy” relating to those subjects. Second, it is possible to identify the content authors who may be considered authorities or influencers for particular subjects, i.e., by tracking the number of people linking to the content generated by those authors.

In addition, embodiments of the present invention are operable to track what subject matter specific individuals are either linking to or writing about over time. That is, a profile of the person who creates a set of documents may be generated over time and used as a representation of that person's preferences and interests. By indexing individuals according to these categories, it becomes possible to identify specific individuals as authorities or as influential with respect to specific subject matter. That is, for example, if a particular individual posts a significant amount of content relating to digital music players, that individual's level of authority (or influence) with regard to digital music players can be determined by identifying how many other individuals who are also interested in or authoritative with respect to digital music players (as tracked through their posts and links) link to the first individual. This enables the creation of a rich, detailed breakdown of the relative authority of each author across all topics in the ontology, based on the number of inbound links by other authors who create documents in that category.

And because the ecosystem “understands” when a piece of content, e.g., post, link, phrase, etc., was created, this information may be used as an additional input to any analysis of the data. For example, using time to enhance the understanding of influence of a document (or of an author who created the document) by looking at the patterns of inbound linking to a set of documents, you can quickly determine if someone is early to link to a document or late to link to a document. If a person consistently links early to interesting documents, then that person is most likely an expert in that field, or at least can speak authoritatively in that field.

Identifying and tracking authorities for particular subjects enables some capabilities not possible using conventional search engine methodologies. For example, the relevance of a new document indexed by a search engine is completely indeterminate because, by virtue of its being new, no one has yet linked to it. By contrast, because embodiments of the present invention track the influence of a particular author in a given subject matter area, new posts from that author can be immediately scored based on the author's influence. That is, using the newfound understanding of time and personality in document creation, we are able to immediately score new documents even though they are not yet linked widely because we know (a) what is in the new/updated document and can therefore use classification methods to determine its topic, and (b) the relative authority of the author in the topic area described. So, in contrast with traditional search engines, the present invention can provide virtually immediate access to the most relevant content.

In addition, the techniques of the present invention may be used to track the sub-topics within a particular subject matter area which are currently being discussed by the most influential authors in that area. For example, one might query the database regarding the topics currently being discussed by the 10 most influential authors in a particular subject matter area.

As mentioned above, tracking the posting of and linking to content by individuals (particularly authoritative individuals) over time essentially results in a collaborative filtering effect for any given subject or topic. Therefore, instead of relying on the editorial choices of the available news sources on the Web to inform one as to what is currently important, the collaborative filter enabled by the present invention may be used to provide vastly different perspectives on what is important and why.

For example, the present invention may be employed to track to what articles at the major news sites bloggers are currently linking. That is, the way in which the data acquired by the tracking site are organized allows not only searching by subject matter or author (i.e., “deep” searches), but by time (i.e., “wide” search). So, for example, all of the blog posts of the past 3 hours (or even within a rolling time window) may be evaluated to identify the most-linked-to news stories (and/or books, movies, etc.) about which some or all bloggers are posting content. This information may then be exposed on a Web page as the topics currently considered important by the blogging community. And given the global scope of the Web, the evolution of the topics of importance can be observed with the rotation of the globe through the use of a rolling window of time. The rolling time window could be extended arbitrarily, e.g., to 12 hours (or 24/48/72 hours, 7 days, etc.), to better identify and rank the specific news articles (and/or books, movies, etc.) to which some or all bloggers are linking.

According to various embodiments, a variety of services may be provided which are based on the data collected according to the invention. For example, a major news service could be provided with what a community of individuals linking to its site are currently saying about the news service and specific articles posted by the news service. In addition, information relating to other aspects of this “community of interest” may be provided to the news service. That is, given that the news service obviously has the attention of the individuals in this community, it could be relevant to identify what else this community might be talking about. In some sense, this could be like having a dedicated and nearly instantaneous focus group on the news service's editorial decisions. This information could be syndicated to the news service and used in any of a wide variety of ways including, for example, to generate story ideas (i.e., this is what our readers are interested in), hiring leads (i.e., many of our readers link to some columnist in Topeka, Kans.), or even be directly exposed on the Web in some way (i.e., here is what our community of readers is saying). It will be understood that a variety of sophisticated data analysis techniques may be employed to provide information of interest from such a data set.

As will be understood, such a community of interest can be identified for any Web site. In fact, different communities of interest for different Web sites, publications, subject matter areas, etc., can be identified and exposed (e.g., on a Web site) to enable users to consume what is being talked about regarding any specific publication or topic, e.g., sports news, technology news, right wing political news, left wing political news, etc.

So, through an understanding of time and individuals, embodiments of the present invention are able to discern categorization and authority, as well as authority within specific categories. And because data analysis of this information is able to “pivot” on a variety of metrics, both “deep” and “wide” searches may be effected to yield a variety of interesting information which is beyond the capabilities of traditional search technology.

Moreover, the ecosystem method of aggregation and search described herein may be applied in a wide variety of contexts. For example, an ecosystem may be implemented to track the way individuals sell things on the Internet. Thus, for example, if an individual posts an auction on an auction site, this event could trigger the generation of a ping or other notification mechanism which precipitates the transmission of a crawler which parses, indexes, and scores the newly posted auction in a manner similar to that described above. Another example is the release of a new book on a large retailer's site. In fact, any type of content published on the Web or Internet can be indexed and scored in this manner. Another example is the publication of press releases on the PR Newswire.

As will be understood, the timely capture of such publications enables a variety of additional services. For example, because a person having significant influence in the market for digital music players can be readily identified, such a person may wish to be an advertising affiliate and post notifications on his site of specific types of events (e.g., the publication of an auction for a digital music player) which are tailored specifically to his visitors. Such an individual might also want a “live” feed from publishers and sites which notifies him of publication events relating to his field of interest or expertise.

Similarly, instead of pushing company news to the PR Newswire, a company can post it to its own site and ping or send changes information to a tracking site which then acquires, indexes and scores the information for use in any of a variety of ways. For example, individuals can subscribe to filters which will cause them to be notified of such posts relating to specific topics.

In another example, when an employment related site posts a new resume, a tracking site can be notified, and the resume can be indexed and scored such that employers who have subscribed to appropriate filters can then be notified if the posted resume fits their criteria. To make the parsing of the resume information easier, the resume can have a standardized format and may, for example, comprise a templated XML document. This approach also allows the publisher of the content, e.g., the job applicant, to retain some amount of control over his data. That is, because the content, e.g., the resume, is typically published on the content creators' site, the content creator can continue to exercise editorial control, including taking the information down.

As should be apparent, the event-driven ecosystem of the present invention looks at the World Wide Web in a different way than conventional search technologies. That is, the approach to data aggregation and search described herein understands timeliness (e.g., two minutes old instead of two weeks old), time (i.e., when something is created), and people and conversations (i.e., instead of documents). Thus, the ecosystem of the present invention enables a variety of applications which have not been possible before. For example, the ecosystem of the present invention enables sophisticated social network analysis of dynamic content on the Web. The ecosystem can track not only what is being said, but who is saying it, and when. Using such an approach, it is possible to identify the first person who was first to articulate something on the Web. It is possible to analyze how ideas propagate on the Web; to determine who is influential, authoritative, or popular (e.g., by how many people link to this person). It is also possible to determine when people linked to a particular person. This kind of information may be used to enable many kinds of further analysis never before practicable.

For example, the blogosphere often “lights up” with respect to a particular topic (e.g., the President's National Guard scandal, rollout of the iPod mini at MacWorld Expo, etc.) in response to a recent article or news report. That is, many bloggers start “conversing” about the topic in response to the breaking of the news in the mainstream media. Not only does the present invention enable tracking of these conversations, it also enables the identification of individuals who were talking about the topic before release of the news. As will be understood, the ability to identify such “conversation starters” or influencers relating to particular topics is extremely valuable from a number of perspectives.

According to other embodiments, the ecosystem of the present invention can enable meaningful tracking of return on investment (ROI) for public relations. Conventional techniques for doing this are ineffective in that they don't typically provide much meaningful information. For example, one approach involves simply putting together a scrap book including any article in which a company was mentioned over some period of time, e.g., typically 30-90 days. Other than frequency, this information provides almost no other qualitative or quantitative information which may be readily used by the company to determine whether their PR dollars have been well spent. In fact, to date, there are virtually no consistent or reliable techniques for determining the effectiveness of PR dollars.

By contrast, the ecosystem of the present invention enables real-time tracking of conversations which are specifically about a particular marketing campaign including, for example, who is talking about the campaign and what they are actually saying about it. Thus, not only can a company identify the best way to create a “buzz” about their products, but it can also track the buzz, and, through timely access to dynamic content, tie it directly to PR dollars spent. The tracked conversations and related content are used to build advertising from conversations which are important to the brand's identity, and its community of customers. For example, conversations about a topic of interest are selected and integrated in an ad unit and/or related web page, and used to build a relationship with the relevant community through the use of syndicated content and links to the author/blogger. The landing page for the ad often rises in a search optimization, thus driving traffic to the blogger.

PR crises can also be tracked and managed using the ecosystem of the present invention. For example, if an event has occurred which is potentially damaging to a company's reputation, e.g., a news story about a defective product, the conversations about the event in which influential individuals are participating may be tracked for the purpose of devising an appropriate strategy for dealing with the crisis.

Media outlets (e.g., news organizations) can leverage the ecosystem architecture in a wide variety of ways. For example, the ecosystem may be used by a news site to understand how people are responding to its stories. That is, such outlets can incorporate event notification into their publishing systems so that each time an article is published, they ping the ecosystem to get indexed as described above. Then they can see who is talking about and linking to those stories and what they are saying.

Similarly, the operator of a news site can ask for the most popular stories published on its site in the past 12 hours, e.g., as indicated by the number of links to those stories. This “buzz” about a story can also be tracked over time, or compared to the buzz generated by a story about the same topic from a competitor's site. In addition, some measure of “scoop” protection may also be ensured in that the time of the ping (which corresponds to the original posting of a story) is stored in the database.

To add another layer, not only can the news site track the buzz, some of the tracked information can be embedded in the original story on the news site so that readers can see what others are saying about the story, e.g., a real-time “letters to the editor.” More generally, representations of the near real time information available from the database (e.g., as embodied in graphs and charts or even raw data) can be presented live via a variety of media. For example, such information feeds could be provided in television programs in association with particular topics or as real time feedback for television programs (e.g., news, variety, talk shows, talent search, etc.).

Media outlets can also mine the ecosystem database to identify authoritative individuals who might be useful as sources for new articles, or might be attractive to recruit as new employees. More generally, because the database indexes information by authority, a search could be conducted for the most influential or authoritative people in any given subject matter area for any reason whatsoever.

Embodiments of the invention, including the methods, apparatus, modules, engines, and devices described herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor. Method steps of the invention can be performed by a programmable processor executing a program of instructions to perform functions of the invention by operating on input data and generating output.

Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It will be understood that the functions and processes described herein may be implemented in a variety of other ways. It will also be understood that each of the various functional modules described may correspond to one or more computing platforms in a network. That is, the methods, functions, services and processes described herein may reside on individual machines or be distributed across or among multiple machines in a network or even across networks. It should therefore be understood that the present invention may be implemented using any of a wide variety of hardware, network configurations, operating systems, computing platforms, programming languages, service oriented architectures (SOAs), communication protocols, etc., without departing from the scope of the invention.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for conversational advertising, the method comprising:
monitoring online commentary data published on a data network, including:
identifying commentary data on one or more electronic forums accessible over the data network, the commentary data associated with an electronic advertisement, and
filtering the identified commentary data according to one or more parameters to define filtered commentary data;
determining advertisement content based on the filtered commentary data; and
providing the determined advertisement content to the electronic advertisement over the data network.

2. The computer-implemented method of claim 1, the parameters including one or more of: conversation content, conversation volume, and a designated timeframe.

3. The computer-implemented method of claim 2, the conversation content including one or more of: a brand, a product, a service, an advertiser, and a URL.

4. The computer-implemented method of claim 1, the parameters including one or more of: a topic, a tag, a keyword, an index, a link, a classification scheme, an authority, and a relevance measure.

5. The computer-implemented method of claim 1, the electronic advertisement being updated to include the determined advertisement content, the method further comprising:
identifying further commentary data on one or more of the electronic forums accessible over the data network, the further commentary data associated with the updated electronic advertisement;
filtering the identified further commentary data according to one or more parameters to define filtered further commentary data;
determining further advertisement content based on the filtered further commentary data; and
providing the determined further advertisement content to the updated electronic advertisement over the data network.

6. The computer-implemented method of claim 1, determining the advertisement content including:
selecting at least a portion of the filtered commentary data.

7. The computer-implemented method of claim 1, determining the advertisement content including:
excluding at least a portion of the filtered commentary data.

8. The computer-implemented method of claim 1, determining the advertisement content including:
retrieving the advertisement content from a storage medium.

9. The computer-implemented method of claim 1, determining the advertisement content including:
receiving a selection of the advertisement content from a moderator associated with the electronic advertisement.

10. The computer-implemented method of claim 1, providing the determined advertisement content including:
sending the determined advertisement content as a metadata feed to the electronic advertisement.

11. The computer-implemented method of claim 1, wherein the electronic forums include a blog.

12. A data processing apparatus for conversational advertising, the apparatus comprising:
a conversation monitoring module coupled to monitor online conversations on a data network, including:
a search module configured to identify commentary data on one or more electronic forums accessible over the data network, the commentary data associated with an electronic advertisement, and
a filtering module coupled to filter the identified commentary data according to one or more parameters to define filtered commentary data;
an advertising content determining module coupled to determine advertisement content based on the filtered commentary data; and
a dynamic update module coupled to provide the determined advertisement content to the electronic advertisement over the data network.

13. The data processing apparatus of claim 12, the parameters including one or more of: conversation content, conversation volume, and a designated timeframe.

14. The data processing apparatus of claim 13, the conversation content including one or more of: a brand, a product, a service, an advertiser, and a URL.

15. The data processing apparatus of claim 12, the parameters including one or more of: a topic, a tag, a keyword, an index, a link, a classification scheme, an authority, and a relevance measure.

16. The data processing apparatus of claim 12, determining the advertisement content including:
selecting at least a portion of the filtered commentary data.

17. The data processing apparatus of claim 12, determining the advertisement content including:
excluding at least a portion of the filtered commentary data.

18. The data processing apparatus of claim 12, determining the advertisement content including:
retrieving the advertisement content from a storage medium.

19. The data processing apparatus of claim 12, determining the advertisement content including:
receiving a selection of the advertisement content from a moderator associated with the electronic advertisement.

20. The data processing apparatus of claim 12, providing the determined advertisement content including:
sending the determined advertisement content as a metadata feed to the electronic advertisement.
